(19) United States
(12) Patent Application Publication
(10) Pub. No.: US 2015/0028694 A1
(43) Pub. Date: Jan. 29, 2015

(54) POWER COUPLINGS IN TRANSMITTERS FOR WIRELESS POWER TRANSMISSION

(71) Applicant: DvineWave Inc., San Ramon, CA (US)

(72) Inventors: Michael A. Leabman, San Ramon, CA (US); Gregory Scott Brewer, Livermore, CA (US)

(73) Assignee: DvineWave Inc., San Ramon, CA (US)

(21) Appl. No.: 13/950,536

(22) Filed: Jul. 25, 2013

(51) Int. Cl. H02J 17/00; H02J 7/02

(52) U.S. Cl. CPC H02J 17/00; H02J 7/025
USPC 307/149

(57) ABSTRACT

The present disclosure may provide various electric transmitter arrangements which may be used to provide wireless power transmission (WPT) while using suitable WPT techniques such as pocket-forming. In some embodiments, transmitters may include one or more antennas connected to at least one radio frequency integrated circuit (RFIC) and one microcontroller. Transmitters may include communications components which may allow for communication to various electronic equipment including phones, computers and others. Transmitters for wireless power transmission may be feed by a power source, which may have suitable connection with transmitters through several power couplings, including screw caps for light sockets, cables, power plugs among others. Power couplings may depend on final application and user preferences.

### CROSS-REFERENCES TO RELATED APPLICATIONS

The present disclosure is related to U.S. Non-Provisional patent application Ser. Nos. 13/891,340 filed May 10, 2013, entitled Methodology for Pocket-Forming; 13/925,469 filed Jun. 24, 2013, entitled Methodology for Multiple Pocket-Forming; 13/946,082 filed Jul. 19, 2013, entitled Method for 3 Dimensional Pocket-Forming; 13/891,399, filed May 10, 2013, entitled Receivers for Wireless Power Transmission and 13/891,445, flied May 10, 2013, entitled Transmitters for Wireless Power Transmission, the entire content of which are incorporated herein by these references.

### FIELD OF INVENTION

The present disclosure relates to electronic transmitters, and more particularly to transmitters for wireless power transmission.

### BACKGROUND OF THE INVENTION

Electronic devices such as laptop computers, smartphones, portable gaming devices, tablets and so forth may require power for performing their intended functions. This may require having to charge electronic equipment at least once a day, or in high-demand electronic devices more than once a day. Such an activity may be tedious and may represent a burden to users. For example, a user may be required to carry chargers in case his electronic equipment is lacking power. In addition, users have to find available power sources to connect to. Lastly, users must plugin to a wall or other power supply to be able to charge his or her electronic device. However, such an activity may render electronic devices inoperable during charging. Current solutions to this problem may include inductive pads which may employ magnetic induction or resonating coils. Nevertheless, such a solution may still require that electronic devices may have to be placed in a specific place for powering. Thus, electronic devices during charging may not be portable. For the foregoing reasons, there is a need for a wireless power transmission system where electronic devices may be powered without requiring extra chargers or plugs, and where the mobility and portability of electronic devices may not be compromised.

### SUMMARY OF THE INVENTION

The present disclosure provides various power couplings for transmitters which can be utilized for wireless power transmission using suitable techniques such as pocket-forming. All light fixtures have a fixture body and a light socket to hold the lamp and allow for its replacement. Fixtures may also have a switch to control the light. Fixtures require an electrical connection to a power source; permanent lighting may be directly wired, and moveable lamps have a plug to a wall socket for power. Transmitters of the present invention have various power couplings configured to use in a light socket mounted in a ceiling, wall or moveable lamp fixture. The power coupling further includes a pair of wires directly wireable into an electrical service within a building or mobile vehicle and the like. Yet another power coupling includes a plug for insertion into a wall socket of the electrical service. The transmitter includes an Edison screw cap for the typical light socket in lamp fixtures or a double-contact bayonet cap for another type of light socket. All of these type of electrical connection to a power source provide the various power couplings for the transmitter power source.

The transmitters of the present invention with the unique power couplings are employed to emit power RF signals to electronic devices which may incorporate receivers. Such receivers may convert the power RF signals into suitable electricity for powering and charging a plurality of electric devices. Wireless power transmission allows powering and charging a plurality of electrical devices without wires.

A transmitter including at least two antenna elements may generate RF signals through the use of one or more Radio frequency integrated circuit (RFIC) which may be managed by one or more microcontrollers. Transmitters may receive power from a power source, which may provide enough electricity for a subsequent conversion to RF signal. Power source may be connected through a variety of power couplings, which may depend on final application and user preferences.

In an embodiment, a transmitter arrangement includes a screw cap for light sockets connected to an electrical service, which may operate as power coupling for the transmitter.

In a further embodiment, a transmitter arrangement includes bare wires as power couplings to a residential or commercial building electrical service for a power source.

In an even further embodiment, a transmitter arrangement includes a power plug as power coupling to be inserted into a socket in an electrical service.

Transmitter arrangements provided in the present disclosure, as well as possible implementation schemes may provide wireless power transmission while eliminating the use of wires or pads for charging devices which may require tedious procedures such as plugging to a wall, and may turn devices unusable during charging. In addition, electronic equipment may require less components as typical wall chargers may not be required. In some cases, even batteries may be eliminated as a device may fully be powered wirelessly.

### BRIEF DESCRIPTION OF THE DRAWINGS

Non-limiting embodiments of the present disclosure are described by way of example with reference to the accompanying figures which are schematic and are not intended to be drawn to scale. Unless indicated as representing the background art, the figures represent aspects of the disclosure.

FIG. 1 illustrates a wireless power transmission example situation using pocket-forming.

FIG. 2 illustrates a component level embodiment for a transmitter.

FIG. 3 illustrates a transmitter arrangement where a screw cap is used as power coupling.

FIG. 4 illustrates a transmitter arrangement where a bare wires used as power couplings.

FIG. 5 illustrates a transmitter arrangement where a power plug is used as power coupling.

### DETAILED DESCRIPTION OF THE DRAWINGS

“Pocket-forming” may refer to generating two or more RF waves which converge in 3-d space, forming controlled constructive and destructive interference patterns.

“Pockets of energy” may refer to areas or regions of space where energy or power may accumulate in the form of constructive interference patterns of RF waves.

“Null-space” may refer to areas or regions of space where pockets of energy do not form because of destructive interference patterns of RF waves.

“Transmitter” may refer to a device, including a chip which may generate two or more RF signals, at least one RF signal being phase shifted and gain adjusted with respect to other RF signals, substantially all of which pass through one or more RF antenna such that focused RF signals are directed to a target.

“Receiver” may refer to a device including at least one antenna element, at least one rectifying circuit and at least one power converter, which may utilize pockets of energy for powering, or charging an electronic device.

“Adaptive pocket-forming” may refer to dynamically adjusting pocket-forming to regulate power on one or more targeted receivers.

### DESCRIPTION OF THE DRAWINGS

In the following detailed description, reference is made to the accompanying drawings, which form a part hereof. In the drawings, which are not to scale or to proportion, similar symbols typically identify similar components, unless context dictates otherwise. The illustrative embodiments described in the detailed description, drawings and claims, are not meant to be limiting. Other embodiments may be used and/or and other changes may be made without departing from the spirit or scope of the present disclosure.

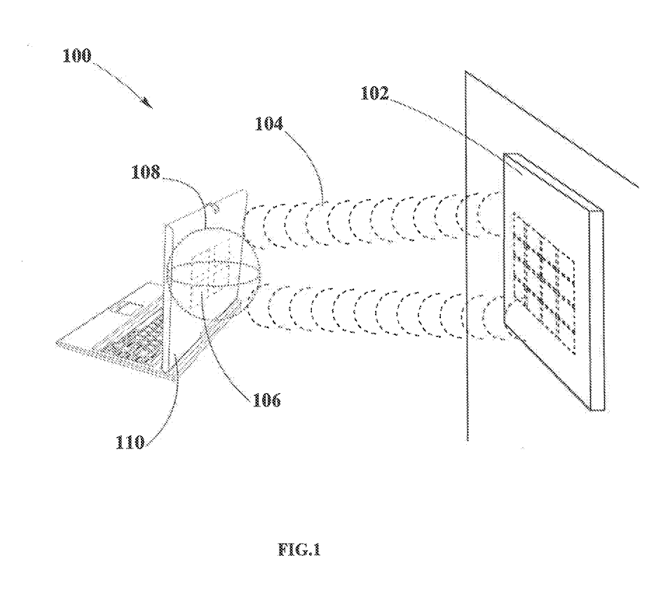

FIG. 1 illustrates wireless power transmission 100 using pocket-forming. A transmitter 102 may transmit controlled Radio RF waves 104 which may converge in 3-d space. These Radio frequencies (RF) waves may be controlled through phase and/or relative amplitude adjustments to form constructive and destructive interference patterns (pocket-forming). Pockets of energy 108 may be formed at constructive interference patterns and can be 3-dimensional in shape whereas null-spaces may be generated at destructive interference patterns. A receiver 106 may then utilize pockets of energy 108 produced by pocket-forming for charging or powering an electronic device, for example a laptop computer 110 and thus effectively providing wireless power transmission. In other situations there can be multiple transmitters 102 and/or multiple receivers 106 for powering various electronic equipment for example smartphones, tablets, music players, toys and others at the same time. In other embodiments, adaptive pocket-forming may be used to regulate power on electronic devices.

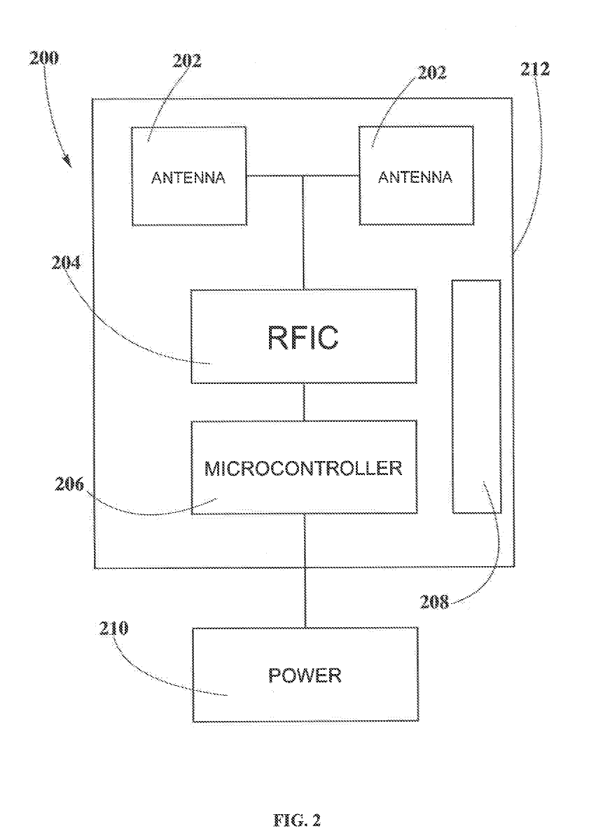

FIG. 2 depicts a basic block diagram of a transmitter 200 which may be utilized for wireless power transmission. Such transmitter 200 may include one or more antenna elements 202, one or more Radio frequency integrated circuit (RFIC) 204, one or more microcontroller 206, a communication component 208, a power source 210 and a housing 212, which may allocate all the requested components for transmitter 200. Components in transmitter 200 may be manufactured using meta-materials, micro printing of circuits, nano-materials, and the like.

Transmitter 200 may be responsible for the pocket-forming, adaptive pocket-forming and multiple pocket-forming through the use of the components mentioned in the foregoing paragraph. Transmitter 200 may send wireless power transmission to one or more receivers 106 in form of radio signals, such signals may include any radio signal with any frequency or wavelength.

Antenna elements 202 may include flat antenna elements 202, patch antenna elements 202, dipole antenna elements 202 and any suitable antenna for wireless power transmission. Suitable antenna types may include, for example, patch antennas with heights from about ⅛ inches to about 6 inch and widths from about ⅛ inches to about 6 inch. Shape and orientation of antenna elements 202 may vary in dependency of the desired features of transmitter 200, orientation may be flat in X, Y, and Z axis, as well as various orientation types and combinations in three dimensional arrangements. Antenna elements 202 materials may include any suitable material that may allow Radio signal transmission with high efficiency, good heat dissipation and the like. Number of antenna elements 202 may vary in relation with the desired range and power transmission capability on transmitter 200, the more antenna elements 202, the wider range and higher power transmission capability.

Antenna elements 202 may include suitable antenna types for operating in frequency bands such as 900 MHz, 2.5 GHz or 5.8 GHz as these frequency bands conform to Federal Communications Commission (FCC) regulations part 18 (Industrial, Scientific and Medical equipment). Antenna elements 202 may operate in independent frequencies, allowing a multichannel operation of pocket-forming.

In addition, antenna elements 202 may have at least one polarization or a selection of polarizations. Such polarization may include vertical pole, horizontal pole, circularly polarized, left hand polarized, right hand polarized, or a combination of polarizations. The selection of polarizations may vary in dependency of transmitter 200 characteristics. In addition, antenna elements 202 may be located in various surfaces of transmitter 200.

Antenna elements 202 may operate in single array, pair array, quad array and any other suitable arrangement, which may be designed in accordance with the desired application.

RFIC 204 may include a plurality of RF circuits which may include digital and/or analog components, such as, amplifiers, capacitors, oscillators, piezoelectric crystals and the like. RFIC 204 may control features of antenna elements 202, such as gain and/or phase for pocket-forming and manage it through direction, power level, and the like. The phase and the amplitude of pocket-forming in each antenna elements 202 may be regulated by the corresponding RFIC 204 in order to generate the desired pocket-forming and null steering. In addition RFIC 204 may be connected to microcontroller 206, which may include a digital signal processor (DSP), PIC-Class microprocessor, central processing unit, computer and the like. Microcontroller 206 may control a variety of features of RFIC 204 such as, time emission of pocket-forming, direction of the pocket-forming, bounce angle, power intensity and the like. Furthermore, microcontroller 206 may control multiple pocket-forming over multiple receivers or over a single receiver. Furthermore, transmitter 200 may allow distance discrimination of wireless power transmission.

In addition, microcontroller 206 may manage and control communication protocols and signals by controlling communication component 208. Microcontroller 206 may process information received by communication component 208 which may send and receive signals to and from a receiver in order to track it and concentrate the pocket of energy 108 on it. In addition, other information may be transmitted from and to receiver 106; such information may include authentication protocols among others. Communication component 208 may include and combine Bluetooth technology, infrared communication, WI-FI, FM radio among others. Microcontroller 206 may determine optimum times and locations for pocket-forming, including the most efficient trajectory to transmit pocket forming in order to reduce losses because obstacles. Such trajectory may include direct pocket-forming, bouncing, and distance discrimination of pocket-forming.

Transmitter 200 may be fed by a power source 210 which may include AC or DC power supply. Voltage, power and current intensity provided by power source 210 may vary in dependency with the required power to be transmitted. Conversion of power to radio signal may be managed by microcontroller 206 and carried out by RFIC 204, which may utilize a plurality of methods and components to produce radio signals in a wide variety of frequencies, wavelength, intensities and other features. As an exemplary use of a variety of methods and components for radio signal generation, oscillators and piezoelectric crystals may be used to create and change radio frequencies in different antenna elements 202. In addition, a variety of filters may be used for smoothing signals as well as amplifiers for increasing power to be transmitted. In order to be connected to a suitable power source 210, transmitter 200 may include a variety of power couplings, which may couple transmitter 200 with power source 210 in dependence of the application and user preferences.

Transmitter 200 may emit pocket-forming with a power capability from few watts to over hundreds of watts. Each antenna may manage a certain power capacity. Such power capacity may be related with the application.

Antenna elements 202, RFIC 204 and microcontrollers 206 may be connected in a plurality of arrangements and combinations, which may depend on the desired characteristics of transmitter 200.

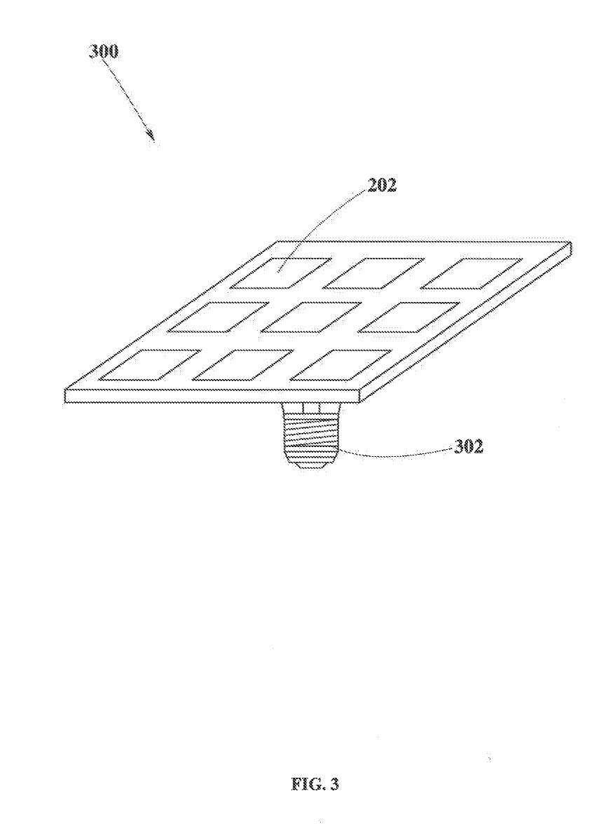

FIG. 3 depicts a flat transmitter 300 of a predetermined size to fit into a number of spaces which includes antenna elements 202. Transmitter 300 includes a screw cap 302. Screw cap 302 connects the transmitter 300 to a light socket, where in the light socket operates as a power source 210 for the transmitter 300.

Screw cap 302 may include a variety of electronics devices, such as, capacitors, inductors, power converters and the like. Such electronic devices may be intended for managing the power source 210, which feeds transmitter 300.

Furthermore, transmitter 300 including screw cap 302 as power connection may increase versatility of transmitter 300, because transmitter 300 is able to be located in every place where a screw cap 302 is received by a light socket.

Transmitter 300 includes several shapes which may vary in dependence with final application and user preferences.

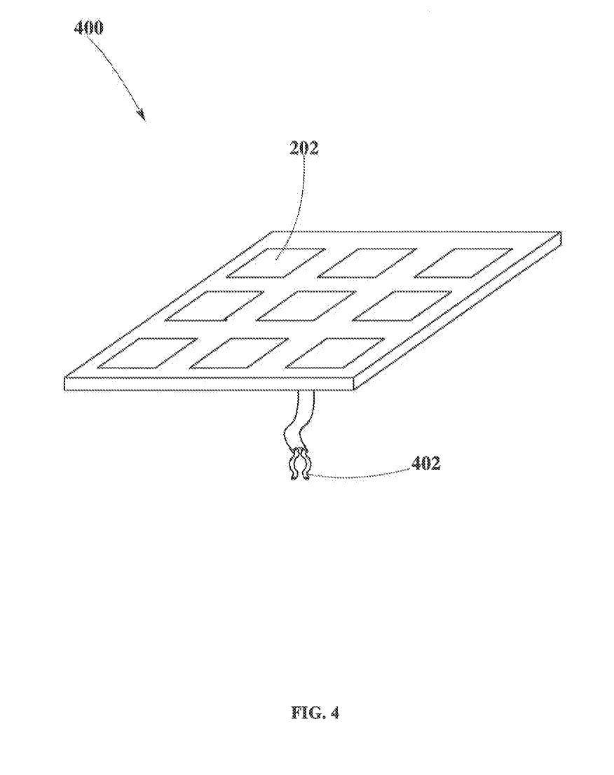

FIG. 4 depicts a fiat transmitter 400 which includes antenna elements 202. Transmitter 400 includes a cable 402 with a pair of wires for connection to the power source 210. Power source 210 includes an electrical service in a building or mobile vehicle and the like.

Cables 402 include labels of positive and negative cables in case of connecting to a DC current power source 210 and/or L1 and L2 cables in case of AC current power source 210. Furthermore, more cables may be included, such cables may be for three-phase power source 210 and a ground cable connection.

Transmitter 400 includes a variety of electronics devices, such as, capacitors, inductors, power converters and the like. Such electronic devices may be intended for managing the power source 210 which may feed transmitter 300.

Transmitter 300 is located in several places due the cables 402, which may be connected to any power source 210, such power source 210 may be AC or DC in dependence with final application and user preferences.

Transmitter 300 includes several shapes which may vary in dependence with final application and user preferences.

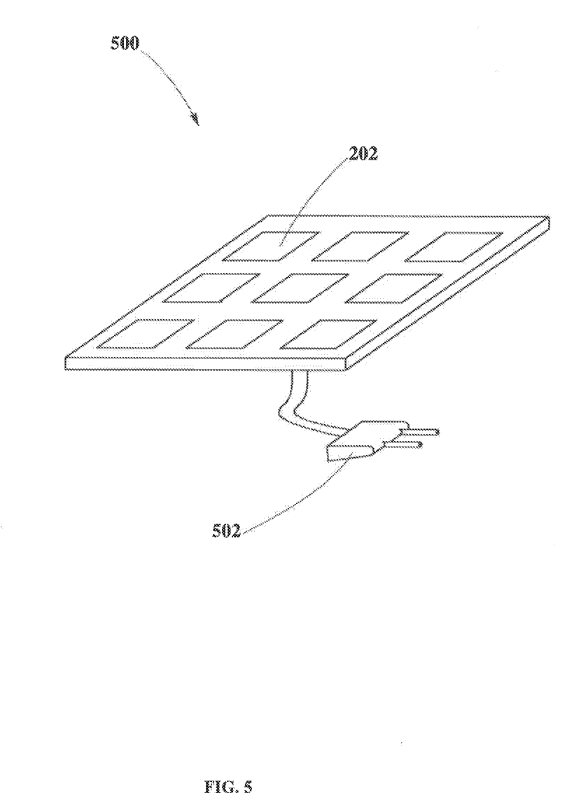

FIG. 5 depicts a transmitter 500 which includes antenna elements 202 in a flat arrangement. Transmitter 300 is connected to a power source 210 through one or more power plug 502, Such power plug 502 complies with the standard of each country and/or region. Power plug 502 is intended to connect transmitter 500 to one or more power outlet on the walls, floors, ceilings and/or electric adapters.

Transmitter 500 includes a variety of electronics devices, such as, capacitors, inductors, power converters and the like. Such electronic devices are intended for managing the power source 210 which feeds transmitter 500.

Transmitter 500 includes several shapes which may vary in dependence with final application and user preferences.

While various aspects and embodiments have been disclosed herein, other aspects and embodiments may be contemplated. The various aspects and embodiments disclosed herein are for purposes of illustration and are not intended to be limiting, with the true scope and spirit being indicated by the following claims.

Having thus described the invention, I claim:

1. A method for wireless power transmission to an electronic device, comprising the steps of:
emitting power RF waves from a pocket-forming transmitter having a power coupling to a power source for generating pockets of energy;
coupling a receiver to an electronic device;
capturing the pockets of energy at the receivers; and
powering or charging the electronic device from the captured pockets of energy.

2. The method for wireless power transmission to an electronic device of claim 1, wherein the power coupling of the transmitter includes a Edison screw cap for insertion into a light socket connected to the power source wherein the power source is an electrical service of a dwelling or mobile power source.

3. The method for wireless power transmission to an electronic device of claim 1, wherein the power coupling of the transmitter includes a cable with a pair of wires for connection to the power source wherein the power source is an electrical service of a dwelling or mobile power source.

4. The method for wireless power transmission to an electronic device of claim 1, wherein the power coupling of the transmitter includes an electrical plug for insertion into a socket connected to the power source wherein the power source is an electrical service of a dwelling or mobile power source.

5. The method for wireless power transmission to an electronic device of claim 1, wherein the power source is connected through a variety of power couplings dependent upon the final application and user preferences.

6. The method for wireless power transmission to an electronic device of claim 1, further including the step of broadcasting short RF signals through antenna elements in the transmitter and the receiver for communication between the transmitter and the receiver to establish a path or channel for the pockets of energy to converge in 3-d space upon antennas of the receiver to charge or power the electronic device.

7. The method for wireless power transmission to an electronic device of claim 6, wherein the short RF signals are standard wireless communication protocols including Bluetooth, Wi-Fi, ZigBee or FM radio.

8. The method for wireless power transmission to an electronic device of claim 1, further includes the step of utilizing adaptive pocket-forming to regulate the pockets of energy to power the electronic device.

9. The method for wireless power transmission to an electronic device of claim 1, wherein power coupling to the transmitter includes connecting the power source to a microcontroller within the transmitter for controlling a radio frequency integrated chip for driving at least two antennas for pocket-forming and for adjusting the transmitter antennas to form the pockets of energy used by the receiver in order to charge or power the electronic device.

10. The method for wireless power transmission to an electronic device of claim 6, further comprising the step of operating the receiver in a frequency band of the transmitter wherein the antenna elements of both the receiver and transmitter include vertical or horizontal polarization, circularly polarized, right hand or left hand polarization, elliptical polarization or any combination thereof.

11. The method for wireless power transmission to an electronic device of claim 1, wherein the power source connected to the transmitter through power coupling includes AC or DC power.

12. A wireless power transmission to an electronic device, comprising:
a pocket-forming transmitter having a power coupling to a power source for emitting power RF waves to form pockets of energy that converge in 3-d space; and
a receiver connected to an electronic device for capturing the pockets of energy converging in 3-d space through antennas to charge or power the electronic device.

13. The wireless power transmission to an electronic device of claim 12, wherein the power coupling of the transmitter includes a Edison screw cap for insertion into a light socket connected to the power source wherein the power source is an electrical service of a dwelling or mobile power source.

14. The wireless power transmission to an electronic device of claim 12, wherein the power coupling of the transmitter includes a cable with a pair of wires for connection to the power source wherein the power source is an electrical service of a dwelling or mobile power source.

15. The wireless power transmission to an electronic device of claim 12, wherein the power coupling of the transmitter includes an electrical plug for insertion into a socket connected to the power source wherein the power source is an electrical service of a dwelling or mobile power source.

16. The wireless power transmission to an electronic device of claim 12, wherein the transmitter and the receiver further include communication circuitry for sending short RF signals between the transmitter and the receiver to establish a path or channel for the pockets of energy to converge in 3-d space upon antennas of the receiver to charge or power the electronic device.

17. The wireless power transmission to an electronic device of claim 16, wherein the short RF signals are standard wireless communication protocols including Bluetooth, Wi-Fi, ZigBee or FM radio.

18. An apparatus for wireless power transmission to an electronic device, comprising:
a pocket-forming transmitter having power couplings for generating power RF waves to form pockets of energy for wirelessly transmitting power in the form of pockets of energy; and
a receiver connected to an electronic device for capturing the pockets of energy through antennas and for establishing an operating voltage for the electronic devices.

19. The apparatus for wireless power transmission to an electronic device of claim 18, further including communication circuitry in the receiver and transmitter wherein the communication circuitry utilizes Bluetooth, infrared, FM radio or Zigbee for the communication protocols between the receiver and the transmitter.

20. The apparatus for wireless power transmission to an electronic device of claim 17, wherein the power coupling of the transmitter includes a Edison screw cap for insertion into a light socket connected to the power source wherein the power source is an electrical service of a dwelling or mobile power source.

21. The apparatus for wireless power transmission to an electronic device of claim 19, wherein the power coupling of the transmitter includes a cable with a pair of wires for connection to the power source wherein the power source is an electrical service of a dwelling or mobile power source.

22. The apparatus for wireless power transmission to an electronic device of claim 19, wherein antenna elements of the transmitter and the receiver operate in similar band frequencies that allow a multichannel operation of pocket-forming to power one or more electronic devices.

23. The apparatus for wireless power transmission to an electronic device of claim 19, wherein the power coupling of the transmitter includes an electrical plug for insertion into a socket connected to the power source wherein the power source is an electrical service of a dwelling or mobile power source.
